(19) United States
(12) Patent Application Publication
(10) Pub. No.: US 2006/0044393 A1
(43) Pub. Date: Mar. 2, 2006

(54) Camera system

(75) Inventors: Koujiro Yoneda, Takatsuki-shi (JP); Takahiro Iwasawa, Kyoto-shi (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/215,115

(22) Filed: Aug. 31, 2005

(30) Foreign Application Priority Data
Aug. 31, 2004 (JP) 2004-252364

(51) Int. Cl. H04N 3/28

(52) U.S. Cl. 348/206

(57) ABSTRACT

The camera system of the present invention comprises: an image pickup unit of an X-Y address system; a horizontal scanning unit and a vertical scanning unit for scanning the image pickup unit by the X-Y address system; a main scanning direction controller which, in accordance with a main scanning direction control signal that determines a main scanning direction to be either in horizontal direction or in vertical direction, performs control by having one of either the horizontal scanning unit or the vertical scanning unit as the main scanning direction and having the other one as a subsidiary scanning direction; an output unit for outputting an image signal which is read out as a result of scanning the image pickup unit by the horizontal scanning unit and the vertical scanning unit; and a signal processing circuit which produces the main scanning direction control signal and also cuts out the image data outputted from the output unit in accordance with an output pixel number of an output device that is connected to the output unit. Provided that a larger pixel number out of either a horizontal direction pixel number or a vertical direction pixel number in the output device is set as a reference pixel number, a pixel number in the image pickup unit is equal to or larger than the reference pixel number both in the horizontal direction and the vertical direction.

### BACKGROUND OF THE INVENTION

1. Field of the Invention

The present invention relates to a camera system and an image sensor, which output images by performing signal-processing on output signals of an image sensor in an X-Y address system. More specifically, it relates to a signal processing technique which is used in a case where the aspect ratio of an image pickup unit in the image sensor is different from the aspect ratio of an output device for display/printing the image.

2. Description of the Related Art

FIG. 4 shows a camera system which uses a conventional image sensor. In FIG. 4, reference numeral 100 is an image sensor, and 200 is a signal processing circuit (DSP). The image sensor 100 comprises: an image pickup unit (area sensor) 101 which performs scanning by an X-Y address system; a horizontal scanning unit 102 which scans the image pickup unit 101 in the horizontal direction according to the X-Y address system; a vertical scanning unit 103 which performs scanning in the vertical direction; and an output unit 104 for outputting image signals which are read out as a result of scanning the image pickup unit 101 by the horizontal scanning unit 102 and the vertical scanning unit 103.

The image pickup unit 101 has a structure in which a plurality of unit pixel 101a are arranged in crosswise matrix. Each unit pixel 101a is constituted of: a photoelectrical conversion element 101b for photoelectrical-converting the incident light; a reading out unit 101c for reading out the image signal obtained in the photoelectrical conversion element 101b; and a reset unit 101d for resetting the photoelectrical conversion element 101b. The aspect ratio of the image pickup unit 101 is 4:3 as in a regular case, and the typical example thereof is 640 (pixels)×480 (pixels)

The signal processing circuit 200 comprises: a CPU 201 for managing the system; a timing generator (TG) 202 for outputting a control signal (sensor driving pulse) Sc which drive-controls the image sensor 100 in accordance with the drive-control from the CPU 201; AFE (analog-front-end) 203 for performing sampling and AD conversion of an image signal So which is outputted from the image sensor; a signal processor 204 for performing signal processing on a digital signal outputted from the AFE 203 by using a memory 207 in accordance with a command form the CPU 201; the memory 207 for storing image data which is obtained in the signal processor 204; an I/F (interface) unit 205 for externally outputting the signals processed in the signal processor 204; and a memory controller 206 for controlling the memory 207 in accordance with the command from the CPU 201.

The horizontal scanning unit 102 and the vertical scanning unit 103, which scan the image pickup unit 101 by the X-Y address system, are driven by the control signal Sc from the timing generator 202 of the signal processing circuit 200.

The CPU 201 transmits the control signal Sc used for driving to the image sensor 100 through the timing generator 202. As a result, the CPU 201 controls the horizontal scanning unit 102 and the vertical scanning unit 103 to be under a state where scanning by the horizontal scanning unit 102 is the main scanning and scanning by the vertical scanning unit 103 is the subsidiary scanning. The image pickup unit 101 is scanned according to the above-described scan control thus enabling to obtain an object image.

The image signal So outputted from the output unit 104 is inputted to the signal processing circuit 200. The image signal So is sampled and A/D-converted in the AFE 203 and transmitted to the signal processor 204. The signal processor 204 produces image data by performing signal processing on the image signal So, temporarily stores the produced image data in the memory 207, and then reads out the data. The signal processor 204 performs crosswise conversion of the image when reading out the image data from the memory 207.

FIG. 5A and FIG. 5B show the state where the image data is outputted to a rectangular output device 300 which is sued in a portable telephone and the like. In the rectangular output device 300, the aspect ratio is reversed (3:4) from that of the above-described image sensor 100. That is, in the image pickup unit 101, the size in the horizontal direction is 640 pixels and the size in the vertical direction is 480 pixels (VGA (Video Graphics Array)). In the output device 300, the size in the horizontal direction is 480 pixels and the size in the vertical direction is 640 pixels.

As shown in FIG. 5, the image pickup unit 101 is scanned with the horizontal direction being the main scanning direction. Thus, the reading out direction becomes the horizontal direction with respect to an object. In the drawing, B1 is the image data which is outputted as the image signal So from the output unit 104 of the image sensor 100. The image data B1 has the view angle of 640 (pixels)×480 (pixels). The image data B1 is inputted to the signal processor 204 through the AFE 203 of the signal processing circuit 200.

As shown in FIG. 5B, the CPU 201 controls the signal processor 204, and the signal processor 204 produces image data B2 by cutting out the data in a range of 480 (pixels)×640 (pixels) view angle for the output device 300 from the image data B1 of 640 (pixels)×480 (pixels) view angle. The image data B2 is produced for aligning the view angle with the output device 300. The image data B2 is outputted to the output device 300 through the I/F unit 205. The output device 300 outputs (displays or prints) the square-shape image data B2 of 480 (pixels)×480 (pixels) view angle.

FIG. 6A and FIG. 6B show the state where an image is picked up and outputted in such a manner that the aspect ratio of the image sensor 100 are aligned with that of the output device 300. In that case, an image pickup element is rotated by 90° (rotated clockwise by 90° in the drawing) for picking up an image so that the original horizontal scanning direction becomes vertical going from the bottom towards the top of the object after the rotation. FIG. 6A shows a posture of the obtained image data B4 in the original view angle (the original direction of the object). As a result, it is considered in this case that the object is picked up sideways as the image. Thus, at the time of output, it is rotated by 90° using the memory 207 (rotated counterclockwise by 90° in the drawing) so as to be outputted as image data B5 as shown in FIG. 6B.

As another related art which is different from the one described above, there is an image sensor as disclosed in Japanese Patent Unexamined Publication No. 2002-13564, in which crosswise pixels of an image pickup unit are formed in a square shape so that output can be performed by aligning the aspect ratio with that of an output device.

In a conventional image pickup device, for outputting an image by maintaining its picked up view angle, there are some pixels to be sacrificed (640 (pixels)×480 (pixels)→480 (pixels)×480 (pixels)) since it is cut out in the manner as shown in FIG. 5. Also, in the output device 300, there generates an unnecessary area B3 at two regions in the vertical direction of FIG. 5B.

Further, for having the rotated image, it is necessary to provide a memory as shown in FIG. 6 and perform processing to rotate the image on the memory. That is, it is necessary to have a memory for one frame or more within the camera system, which increases the cost of the camera system.

### SUMMARY OF THE INVENTION

The main object of the present invention therefore is to make it possible by a simple structure to obtain an output image with the aspect ratio in accordance with an output device to be used without generating unnecessary image.

In order to overcome the aforementioned problems, the camera system of the present invention comprises: an image pickup unit of an X-Y address system; a horizontal scanning unit and a vertical scanning unit for scanning the image pickup unit by the X-Y address system; a main scanning direction controller which, in accordance with a main scanning direction control signal that determines a main scanning direction to be either in horizontal direction or vertical direction, performs control by having one of either the horizontal scanning unit or the vertical scanning unit as the main scanning direction and having the other one as a subsidiary scanning direction; an output unit for outputting an image signal which is read out as a result of scanning the image pickup unit by the horizontal scanning unit and the vertical scanning unit; and a signal processing circuit which produces the main scanning direction control signal and also cuts out image data outputted from the output unit in accordance with an output pixel number of an output device that is connected to the output unit. Provided that a larger pixel number out of either a horizontal direction pixel number or a vertical direction pixel number in the output device is set as a reference pixel number, a pixel number in the image pickup unit is equal to or larger than the reference pixel number both in the horizontal direction and the vertical direction.

The minimum image data size in the image pickup unit is set to be the reference pixel number×the reference pixel number. In that case, the pixel number in the horizontal direction and the pixel number in the vertical direction may or may not be equal to each other.

In the above-described structure, it is preferable for the image pickup unit to have unit pixels arranged in crosswise matrix. Each of the unit pixels comprises: a photoelectric conversion element for photoelectrical-converting incident light; a reading-out unit for reading out an imaging signal obtained in the photoelectrical conversion element; and a reset unit for resetting the photoelectrical conversion element.

The image sensor of the present invention comprises: an image pickup unit of an X-Y address system; a horizontal scanning unit and a vertical scanning unit for scanning the image pickup unit by the X-Y address system; a main scanning direction controller which, in accordance with a main scanning direction control signal that determines a main scanning direction to be either in horizontal direction or in vertical direction, performs control by having one of either the horizontal scanning unit or the vertical scanning unit as the main scanning direction and having the other one as a subsidiary scanning direction; an output unit for outputting an image signal which is read out as a result of scanning the image pickup unit by the horizontal scanning unit and the vertical scanning unit; and a signal processing circuit which produces the main scanning direction control signal and also cuts out the image data outputted from the output unit in accordance with an output pixel number of an output device that is connected to the output unit.

In the above-described structure, for the pixel number in the horizontal direction and the pixel number in the vertical direction of the output device, it is preferable to set a larger pixel number of the output device which is connected to the output unit to be larger than the reference pixel number. Further, it is preferable to have the pixel number in the horizontal direction of the image pickup unit and the pixel number in the vertical direction equal to each other.

For outputting the image data to the output device without changing the direction of the image data, the image data is cut out in the signal processing circuit in accordance with the view angle size of the output device. The view angle size of the image data is in a size sufficient to cover the view angle size of the output device. Thus, even if a part of the image data is cut out to be outputted to the output device having a different aspect ratio, there is no sacrifice of the image size and generates no unnecessary area of the data.

Further, for outputting to the output device the image data which is picked up by changing the direction of the image pickup unit with respect to the object, the signal processing circuit outputs the main scanning direction control signal. In accordance with the main scanning direction control signal, the main scanning direction controller switches the main scanning direction from the horizontal direction to the vertical direction. Then, the image data is cut out in the signal processing circuit so as to align the view angle size to that of the output device. By the multiplier effect achieved by changing the direction of the image pickup unit with respect to the object and switching the main scanning direction, it becomes unnecessary to change the aspect ratio even for outputting the image data to the output device having a different aspect ratio. Therefore, it becomes unnecessary to provide a memory for rotating the image data.

With the present invention, for outputting the image data to the output device having a different aspect ratio, there is no sacrifice in the image data size so that it is possible to prevent an unnecessary pixel area from being generated in the image pickup unit. Also, for obtaining the rotated image, it is possible to obtain the output image having the aspect ratio in accordance with the output device without providing a memory for rotation.

In the image sensor and the camera system of the present invention, for outputting the image data to the output device having a different aspect ratio, there is no sacrifice in the image data size so that it is possible to prevent an unnecessary pixel area from being generated in the image pickup unit. Also, it is possible to omit the memory to be used for rotation for obtaining the rotated image. Therefore, the present invention is effective for a small-size camera system and the like to be used in a portable telephone and the like where there is a high demand for achieving a cost reduction and downsizing.

### BRIEF DESCRIPTION OF THE DRAWINGS

Other objects of the present invention will become clear from the following description of the preferred embodiments and the appended claims. Those skilled in the art will appreciate that there are many other advantages of the present invention possible by embodying the present invention.

FIG. 1 is a block diagram for showing the structure of a camera system according to an embodiment of the present invention;

FIG. 2A and FIG. 2B are illustrations for describing normal reading out performed in the camera system of the embodiment;

FIG. 3A and FIG. 3B are illustrations for describing reading out of a rotated image performed in the camera system of the embodiment;

FIG. 4 is a block diagram for showing the structure of a camera system according to a related art;

FIG. 5A and FIG. 5B are illustrations for describing normal reading out performed in the camera system of the related art; and

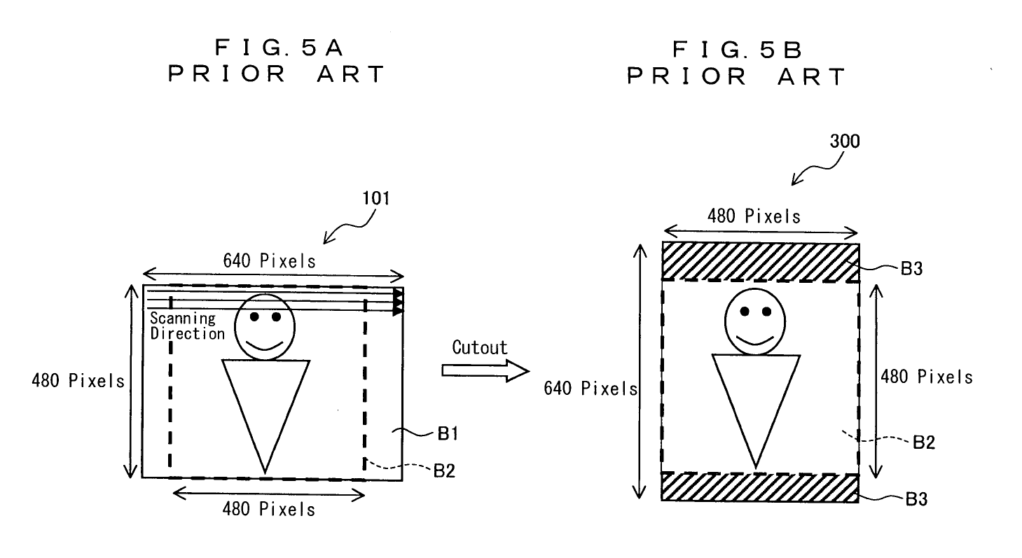

FIG. 6A and FIG. 6B are illustrations for describing reading out of a rotated image performed in the camera system of the related art.

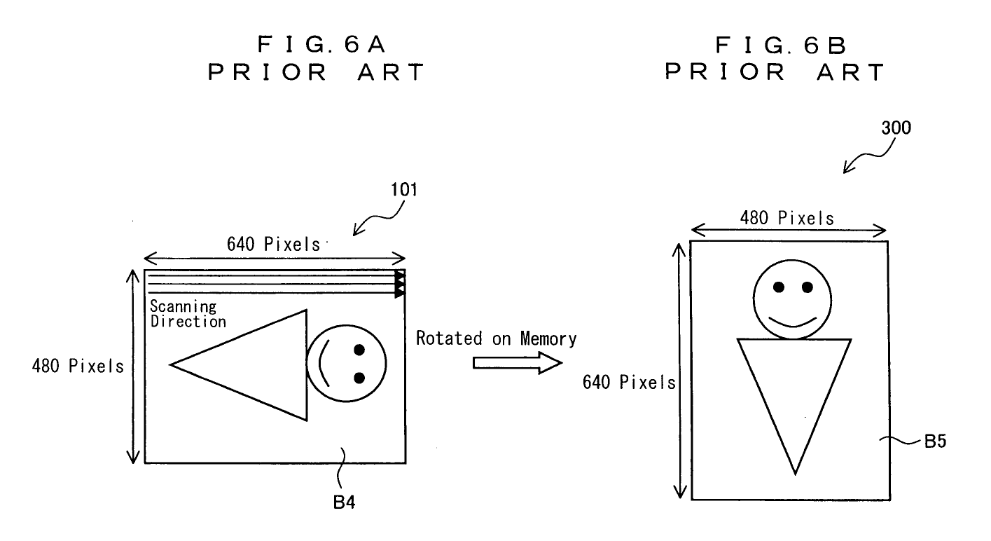

### DETAILED DESCRIPTION OF THE INVENTION

In the followings, an embodiment of the camera system according to the present invention will be described in detail by referring to the accompanying drawings. In each drawing, a memory, a timing generator, and AFE are illustrated to be inside a signal processing circuit (DSP). However, they may be provided outside the signal processing circuit.

### Embodiment

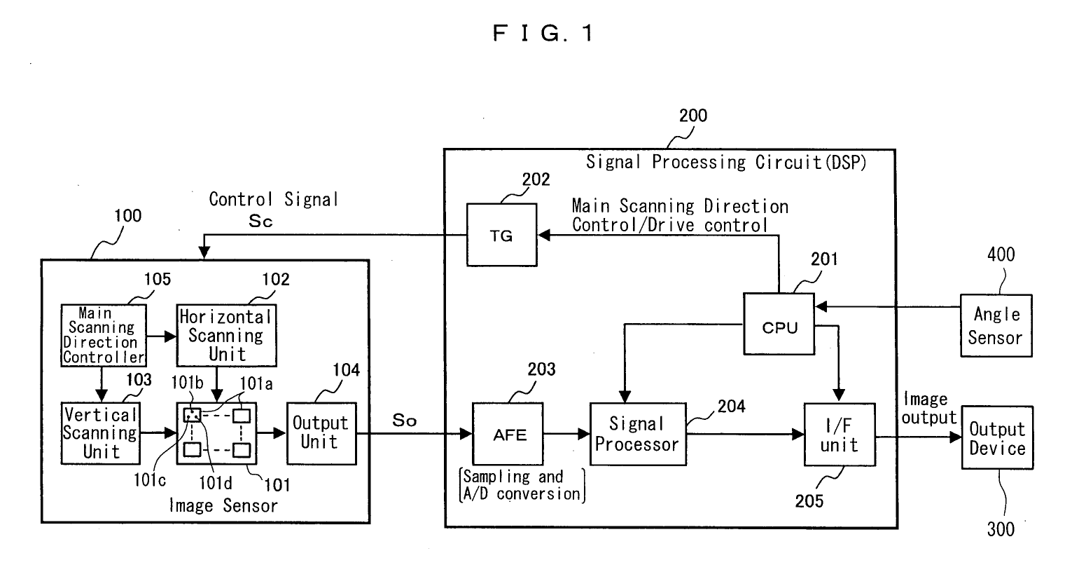

FIG. 1 is a block diagram for showing the structure of the camera system according to the embodiment of the present invention. This camera system is constituted with an image sensor 100 and a signal processing circuit 200.

The image sensor 100 comprises an image pickup unit (area sensor) 101, a horizontal scanning unit 102, a vertical scanning unit 103, an output unit 104, and a main scanning direction controller 105.

The image pickup unit (area sensor) 101 is scanned by an X-Y address system. The horizontal scanning unit 102 scans the image pickup unit 101 in the horizontal direction according to the X-Y address system. The vertical scanning unit 103 scans the image pickup unit 101 in the vertical direction according to the X-Y address system. The horizontal and vertical directions of the above-described image pickup unit 101 indicate the directions of the image pickup device 101 when it is mounted in the first place. Thus, in the description provided below, each direction of the image pickup device 101 is referred to as the horizontal direction (initial state) and the vertical direction (initial state), respectively.

The output unit 104 outputs an image signal which is read out as a result of scanning the image pickup unit 101 by the horizontal scanning unit 102 and the vertical scanning unit 103. The main scanning direction controller 105 controls the horizontal scanning unit 102 and the vertical scanning unit 103 according to a main scanning direction control signal which determines the main scanning direction either in the horizontal direction (initial state) or in the vertical direction (initial state).

The image pickup unit 101 is constituted with a MOS (Metal Oxide Semiconductor) image sensor, for example. However, the image pickup unit 101 may be constituted with other devices such as CCD (Charge Coupled Device) and the like. The image pickup unit 101 has a structure in which a plurality of unit pixels 101a are arranged in crosswise matrix. The unit pixel 101a comprises a photoelectrical conversion element 101b for photoelectrical—converting incident light, a reading out unit 101c for reading out an image signal which is obtained in the photoelectrical conversion element 101b, and a reset unit 101d for resetting the photoelectrical conversion element 101b.

The signal processor circuit 200 is constituted with a DSP (Digital Signal Processor). The signal processing circuit 200 comprises a CPU 201, a timing generator (TG) 200, an AFE (analog-front-end) 203, a signal processor 204, and an I/F (interface) unit 205.

The CPU 201 manages the system. The timing generator (TG) 202 outputs a control signal (sensor driving pulse) Sc. The control signal Sc is a signal which drive-controls the image sensor 100 according to the drive-control from the CPU 201. The AFE 203 performs sampling and A/D conversion of the image signal So which is outputted from the image sensor 100. The signal processor 204 performs signal-processing on a digital signal which is outputted from the AFE 203 according to a command from the CPU 201. The I/F unit 205 externally outputs the signal processed in the signal processor 204. At the time of performing signal-processing on the image signal So in the signal processor 204 and the I/F unit 205, the main and subsidiary scanning directions of the image signal So are kept the same as the output direction thereof from the image sensor 100. Thus, when the image signal So is outputted from the I/F unit 205 and is output-processed (displayed or printed) in the output device 300 to be described later, the main and the subsidiary scanning directions are the main and subsidiary scanning directions of the image pickup unit 101.

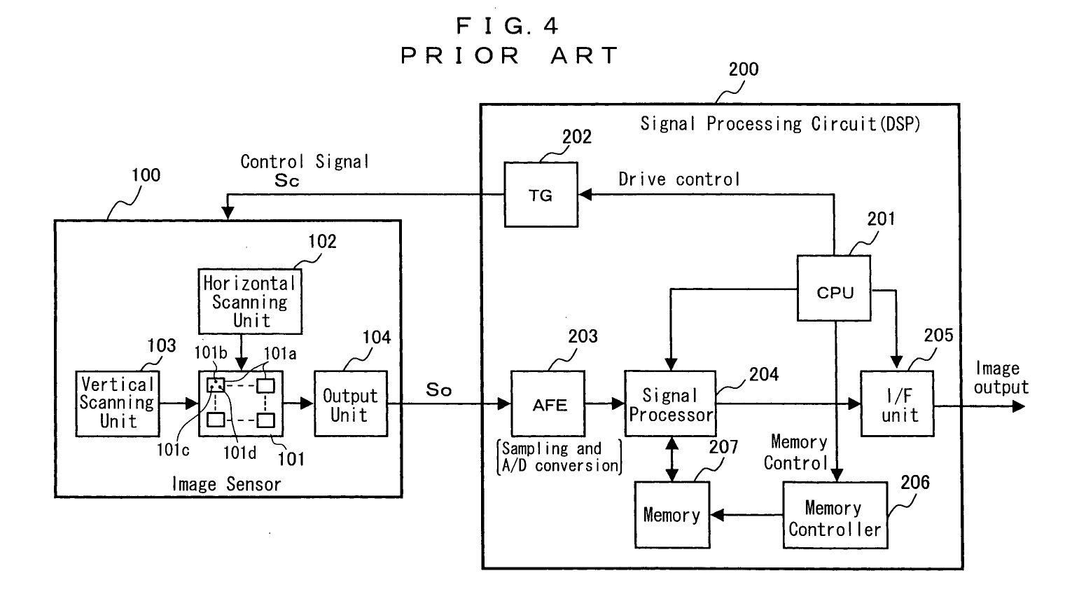

Unlike the structure (see FIG. 4) of the related art, it is unnecessary in this embodiment to provide a memory controller 206 and a memory 207 for rotating the image.

When there is supplied a command for rotating-processing from outside the system or inside the system, the CPU 201 determines the main scanning direction of the image pickup unit 101 and transmits the main scanning direction control signal which designating the determined main scanning direction to the image sensor 100 through the timing generator 202. The main scanning direction control signal is supplied to the image sensor 100 as the control signal Sc.

The CPU 201 determines whether to read out in the horizontal direction (to have the horizontal direction (initial state) as the main scanning direction) or to read out in the vertical direction (to have the vertical direction as the main scanning direction). When it is determined to read out in the vertical direction, the CPU 201 outputs the main scanning direction control signal which designates a direction switching control for changing the reading out direction by 90°. Specifically, in the case where the current main scanning direction is in the vertical direction (initial state), the CPU 201 transmits the main scanning direction control signal for designating to change the main scanning direction (reading out direction) by 90°. In the meantime, when it is determined to read out in the horizontal direction, the CPU 201 outputs the main scanning direction control signal which designates a direction switching control for maintaining the reading out direction as it is. Specifically, in the case where the current main scanning direction is in the horizontal direction (initial state) (normally, it is in this sate), the CPU 201 transmits the main scanning direction control signal for maintaining the main scanning direction (reading out direction) as it is.

The main scanning direction controller 105 controls the horizontal scanning unit 102 and the vertical scanning unit 103 according to the main scanning control signal from the signal processing circuit 200. With this, the main scanning direction controller 105 controls the main scanning direction to be in the direction in accordance with the main scanning direction control signal.

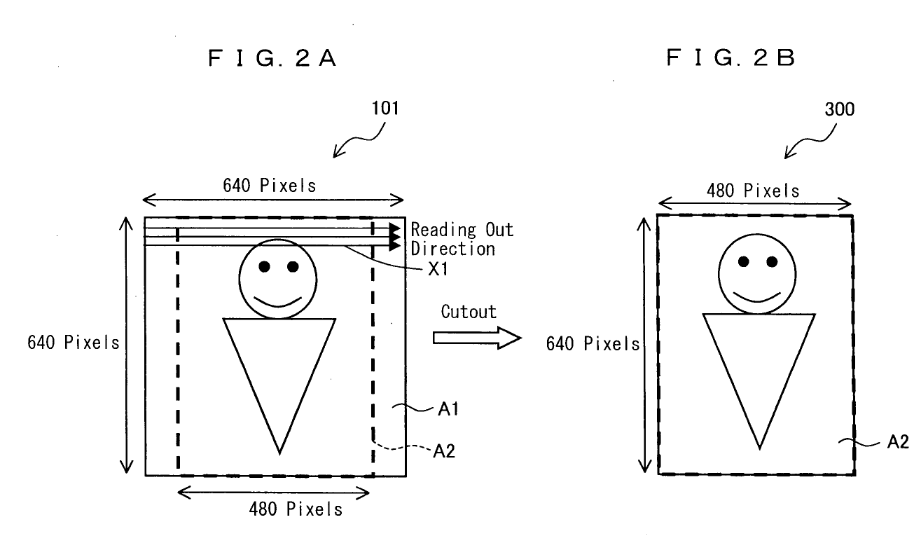

FIG. 2 is an illustration for describing differences between the output form of the image pickup unit 101 and the output (display) form of the output device 300. In this embodiment, in the output device 300 which displays or copies the image output supplied from the signal processing circuit 200, the main scanning direction is maintained the same as the main scanning direction of the image pickup unit 101 (signal processing circuit 200). However, the aspect ratio thereof is different from that of the image pickup unit 101. In the present invention, provided that the pixel number in a side of the output device 200 having a larger pixel number is taken as the reference pixel number, the pixel number in a side of the image pickup unit 101 in a square shape is made equal to the reference pixel number. However, for embodying the present invention, the pixel number in one side of the square-shape image pickup unit 101 may be any numbers as long as it is larger than the reference pixel number. In this embodiment, however, the pixel number in one side of the square-shape image pickup unit 101 is made equal to the reference pixel number for the sake of economic efficiency.

Specifically, in the output device 300, the size of the pixel number in the horizontal direction is set as 480 pixels and the size of the pixel number in the vertical direction as 640 pixels. This is a form which corresponds to so-called VGA. In the meantime, the image pickup unit 101 is in a square shape whose one side has the size of the pixel number equal to the side of the output device 300 with a larger size of the pixel number, i.e. equal to the size of the pixel number (640 pixels) in the vertical direction thereof.

Next, described is the action of the camera system of this embodiment, which is structured in the manner as described above. Described is a control of the action in the case where, first, as shown in FIG. 2, an image is picked up under the sate where the actual horizontal and vertical directions of an object are aligned with the horizontal and vertical directions (initial state) of the image pickup unit 101, and the image signal picked up thereby in the square-shape image pickup unit 101 is outputted to the rectangular output device 300. Specifically, in this image pickup form, an image is picked up while maintaining the camera system to have the horizontal and vertical directions (initial state) of the image pickup unit 101.

First, a rotating processing command (no processing) is supplied to the CPU 201 from outside the system or inside the system. For generating such rotating processing command, the camera system is provided with an angle sensor 400. The angle sensor 400 measures the facing direction of the camera system at the time of picking up the image and supplies the rotating processing command based on the measured result.

Upon receiving the rotating processing command (no processing), the CPU 201 produces a main scanning direction control signal which designates the horizontal direction (initial state) of the image pickup unit 101 as a main scanning direction X1 and the vertical scanning direction as a subsidiary scanning direction. Than, the CPU 201 transmits the control signal to the image sensor 100 through the timing generator 202.

Upon receiving such main scanning direction control signal, the main scanning direction controller 105 performs a control for having no change in the main scanning direction. That is, the horizontal scanning unit 102 and the vertical scanning unit 103 are controlled so that scanning by the horizontal scanning unit 102 becomes the main scanning and scanning by the vertical scanning unit 103 becomes the subsidiary scanning.

With this, the image pickup unit 101 is scanned under the state where the main scanning direction X1 is the horizontal direction (initial state). At this time, as shown in FIG. 2, the reading out direction (main scanning direction) is maintained as it is in the horizontal direction (initial state). The image signal So picked up by the image pickup unit 101 in this state is outputted from the output unit 104 of the image sensor 100. The image data becomes data A1 as shown in FIG. 2A in accordance with the image signal So which is outputted in this manner.

The view angle of the image data A1 becomes 640 (pixels)×640 (pixels) in accordance with the shape of the image pickup unit 101, and the vertical direction of the object is maintained as the vertical direction on the image pickup unit 101 as well. The image data A1 having such property is inputted to the signal processor 204 through the AFE 203 of the signal processing circuit 200.

The CPU 201 controls the signal processor 24. The signal processor 204 cuts out the data in a range of 480 (pixels)×640 (pixels) view angle for the output device 300 from the image data A1 of 480 (pixels)×640 (pixels) view angle for forming the image data A2. The formed image data A2 is outputted to the output device 300 through the I/F unit 205. The output device 300 outputs (displays or prints) the rectangular image data A2 in a view angle of 480 (pixels) in horizontal direction×640 (pixels) in vertical direction.

As described above, it is possible in this embodiment to perform output with the aspect ratio being aligned to that of the output device 300 through simply cutting out the image data. Thus, there is no area without the image to be generated in the output device 300. Further, it is possible to align the view angle in the image sensor 100 and the view angle in the output device.

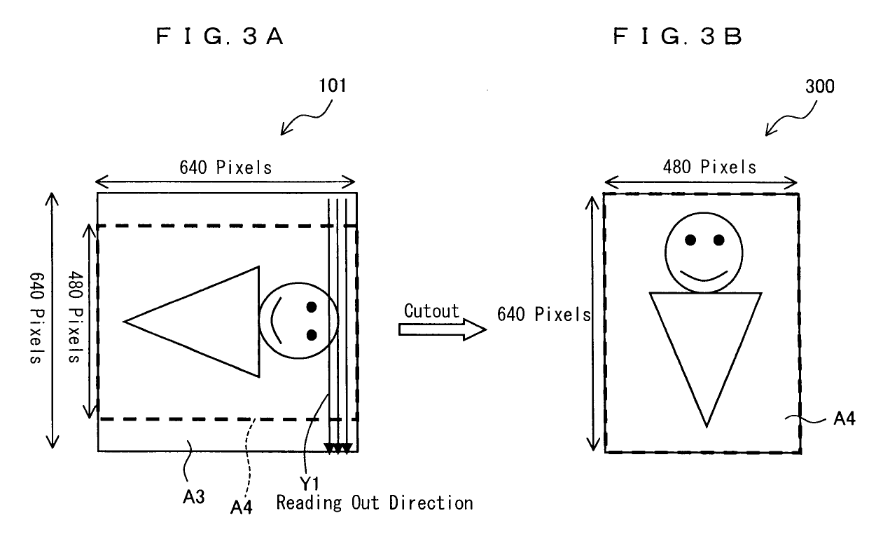

Next, described is a control of the action in the case where, as shown in FIG. 3, an image is picked up under the sate where the actual vertical direction (horizontal direction) of an object is aligned with the horizontal direction (vertical direction) on the image pickup unit 101, and an image signal picked up thereby in the square-shape image pickup unit 101 is outputted to the rectangular output device 300 by maintaining the horizontal and vertical directions of the object. Specifically, in this image pickup form, the image is picked up while slanting the image pickup unit 101 by 90°.

First, a rotating processing command (90°) is supplied to the CPU 201 from outside the system or inside the system. The rotating processing command (90°) is supplied to the CPU 201 from the angle sensor 400, for example.

Upon receiving the rotating processing command (90°), the CPU 201 produces a main scanning direction control signal which designates the vertical direction (initial state) of the image pickup unit 101 as a main scanning direction Y1 and transmits it to the image sensor 100 through the timing generator 202. Upon receiving such main scanning direction control signal, the main scanning direction controller 105 controls the vertical scanning unit 103 and the horizontal scanning unit 102 so that scanning by the vertical scanning unit 103 becomes the main scanning and scanning by the horizontal scanning unit becomes the subsidiary scanning.

With this, as shown in FIG. 3, the image pickup unit 101 is scanned in the state where the main scanning direction Y1 is the vertical direction (initial state). At this time, the reading out direction is changed from the horizontal direction (initial state) to the vertical direction (initial state) The image signal So picked up by the image pickup unit 101 in this state is outputted from the output unit 104 of the image sensor 100.

The image data becomes data A3 as shown in FIG. 3A in accordance with the image signal So which is outputted in this manner. The view angle of the image data A3 becomes 640 (pixels)×640 (pixels) in accordance with the shape of the image pickup unit 101. However, the vertical direction of the object is changed to the horizontal direction (initial state) of the image pickup unit 101 and the horizontal direction of the object is changed to the vertical direction (initial state) of the image pickup unit 101. The image data A3 having such property is inputted to the signal processor 204 through the AFE 203 of the signal processing circuit 200.

The CPU 201 controls the signal processor 204. The signal processor 204 cuts out the data in a range of 480 (pixels)×640 (pixels) view angle for the output device 300 from the image data A3 of 640 (pixels)×640 (pixels) view angle for forming the image data A4. The view angle after cutout becomes 480 (pixels) along the main scanning direction Y1 (in the horizontal direction of the object) which is the vertical direction at the time of picking up the image, and 640 pixels along the subsidiary scanning direction (in the vertical direction of the object) which is the subsidiary scanning direction at the time of picking up the image. The cutout image data A4 is outputted to the output device 300 through the I/F unit 205.

In the output device 300, the main scanning direction Y1 (the horizontal direction of the object) is maintained as the main scanning direction (the horizontal direction) and the subsidiary scanning direction (the vertical direction of the object) is maintained as the subsidiary scanning direction (the vertical direction). Therefore, in the output device 300, there are 480 (pixels) along the main scanning direction (in the horizontal direction of the object) at the time of picking up the image, and 640 pixels along the subsidiary scanning direction (in the vertical direction of the object) at the time of picking up the image. The output device 300 outputs (displays or prints) the rectangular image data A4 in a view angle of 480 (pixels)×640 (pixels).

In this manner as described above, it is possible to obtain the image data A4 in the state as if it is rotated by 90° on the appearance with respect to the horizontal and vertical directions (initial state) of the image pickup unit 101. For performing such rotating processing on the appearance, it is unnecessary to provide a memory within the signal processing circuit 200 for the rotating processing.

The present invention has been described in detail by referring to the most preferred embodiments. However, various combinations and modifications of the components are possible without departing from the sprit and the broad scope of the appended claims.

What is claimed is:

1. A camera system, comprising:
an image pickup unit of an X-Y address system;
a horizontal scanning unit and a vertical scanning unit for scanning said image pickup unit by said X-Y address system;
a main scanning direction controller which, in accordance with a main scanning direction control signal that determines a main scanning direction to be either in horizontal direction or in vertical direction, performs control by having one of either said horizontal scanning unit or said vertical scanning unit as said main scanning direction and having other one as a subsidiary scanning direction;
an output unit for outputting an image signal which is read out as a result of scanning said image pickup unit by said horizontal scanning unit and said vertical scanning unit; and
a signal processing circuit which produces said main scanning direction control signal and also cuts out said image data outputted from said output unit in accordance with an output pixel number of an output device that is connected to said output unit, wherein
provided that a larger pixel number out of either a horizontal direction pixel number or a vertical direction pixel number in said output device is set as a reference pixel number, a pixel number in said image pickup unit is equal to or larger than said reference pixel number both in horizontal direction and vertical direction.

2. The camera system according to claim 1, wherein said horizontal direction pixel number and said vertical direction pixel number of said image pickup unit are equal to each other.

3. The camera system according to claim 1, wherein
said image pickup unit has unit pixels arranged in crosswise matrix, each of said unit pixels comprising:
a photoelectric conversion element for photoelectrical-converting incident light;
a reading-out unit for reading out an imaging signal obtained in said photoelectrical conversion element; and
a reset unit for resetting said photoelectrical conversion element.

4. An image sensor comprising:
an image pickup unit of an X-Y address system;
a horizontal scanning unit and a vertical scanning unit for scanning said image pickup unit by said X-Y address system;
a main scanning direction controller which, in accordance with a main scanning direction control signal that determines a main scanning direction to be either in horizontal direction or in vertical direction, performs control by having one of either said horizontal scanning unit or said vertical scanning unit as said main scanning direction and having other one as a subsidiary scanning direction; and
an output unit for outputting an image signal which is read out as a result of scanning said image pickup unit by said horizontal scanning unit and said vertical scanning unit.

5. The image sensor according to claim 4, wherein
provided that a larger pixel number out of either a horizontal direction pixel number or a vertical direction pixel number in said output device that is connected to said output unit is set as a reference pixel number, a pixel number in said image pickup unit is equal to or larger than said reference pixel number both in horizontal direction and vertical direction.

6. The image sensor according to claim 5, wherein said horizontal direction pixel number and said vertical direction pixel number of said image pickup unit are equal to each other.
